(19) United States
(12) Patent Application Publication
(10) Pub. No.: US 2015/0221930 A1
(43) Pub. Date: Aug. 6, 2015

(54) ELECTROLESS DEPOSITION OF Bi, Sb, Si, Sn, AND Co AND THEIR ALLOYS

(71) Applicants: Ayyakkannu Manivannan, Morgantown, WV (US); Faith Beck, Pittsburgh, PA (US)

(72) Inventors: Ayyakkannu Manivannan, Morgantown, WV (US); Faith Beck, Pittsburgh, PA (US)

(21) Appl. No.: 14/170,841

(22) Filed: Feb. 3, 2014

(51) Int. Cl. H01M 4/1395; C23C 18/31; C23C 18/16; H01M 4/1393; H01M 4/04

(52) U.S. Cl. CPC H01M 4/1395; H01M 4/1393; H01M 4/0402; C23C 18/1637; C23C 18/1639; C23C 18/1651; C23C 18/1689; C23C 18/31

(57) ABSTRACT

The present invention relates to production of composite materials utilizing an electroless deposition method for coating substrates with bismuth, antimony, tin, silicon, cobalt and their various compositional alloys. Substrates may be materials comprised of copper, brass, carbon, and silicon. These substrates are immersed in aqueous or ethylene glycol based solutions containing soluble ions of the desired coating material. The present invention generates desired coatings at room temperature during a period of immersion of one hour or less. In one exemplary embodiment, the method provides the electroless deposition of silicon onto copper nanoparticles in a room temperature solution of ethylene glycol. The coated nanoparticles may then be processed to form a battery electrode. In another exemplary embodiment, the method provides electroless deposition of tin onto brass foil in a room temperature aqueous solution. Battery electrodes may then be punched from the coated sheet.

### GOVERNMENT INTERESTS

The United States Government has rights in this invention pursuant to the employer-employee relationship of the Government to the inventors as U.S. Department of Energy employees at the National Energy Technology Laboratory.

### FIELD OF THE INVENTION

The disclosure relates to the production of composite materials utilizing an electroless deposition process to produce films of bismuth, antimony, silicon, tin, and cobalt individually as well as their various compositional alloys directly onto various substrate materials of copper, brass, carbon, and silicon. These methods are particularly useful in forming composite and alloy films on materials for use in applications such as battery anodes in lithium, sodium, and magnesium batteries.

### BACKGROUND OF THE INVENTION

Current lithium batteries most often use carbon graphite as the anode electrode and have a theoretical energy density of 372 mAh/g. The energy density of the anodes in practice approaches only 200 mAh/g. Meanwhile, alternative anode materials such as tin, antimony, and bismuth have theoretical energy densities of 991 mAh/g, 660 mAh/g, and 385 mAh/g, respectively. The theoretical energy density of silicon is significantly higher still at 3580 mAh/g.

6C+Li⁺+e⁻ [symbol] LiC₆ [symbol] 372 mAh/g

4Si+15Li⁺+15e⁻ [symbol] Li₁₅Si₄ [symbol] 3580 mAh/g

However, these higher energy density materials are prone to excessive expansion during lithium intercalation, as much as three times their original volume in the case of silicon. This extreme expansion and contraction during cycling leads to structural disintegration of the anode material. The repeated volume changes associated with the alloying and dealloying of the metallic anodes with lithium, lead to crack formation and consequent structural degradation of the anode. The crack formation essentially breaks the electrical contacts within the anode. Consequently, there is a resulting rapid capacity decay during cycling.

Significant research is being performed to overcome these volume change issues. One approach has been the development of composite or alloy materials defined herein as one material incorporated onto or into another. Composite materials where an anode material is incorporated into a second material with ductile properties may allow the ductile material to buffer the volume change during lithium insertion and extraction. An additional approach is to decrease the structural size of the materials in the anode. A decrease in material size through means such as the use of nanoparticles would decrease the scale of volume changes and avoid crack formation and subsequent degradation. A combination of these two strategies is also of interest. Volume changes in battery anode materials may be remedied by incorporating nanosize materials such as silicon within Bi, Sb, Sn, Co etc. along with the ductile substrate material such as copper.

Past attempts to synthesize the materials described have either not been successful and/or rely on undesirable methods of production. Techniques previously used to produce composite materials have relied on methods that are time consuming, energy demanding, or are not environmentally friendly. For example, production of Si nanoparticles alone by ball milling may require 100-200 hours of milling. Incorporation of secondary materials to prevent structural decomposition using methods such as chemical vapor deposition (CVD) and physical vapor deposition (PVD) have high energy demands, are environmentally hazardous, and are prohibitively slow.

Meanwhile, electroless deposition is a well-known process that provides an efficient route for the production of composite materials. Electroless deposition is the process of depositing a coating from a solution derived metallic cation onto a substrate through the reduction of the metallic cation by a chemical reducing agent in solution. Electroless deposition takes place without application of external electric current, where as defined herein an absence of an applied external electric current is the absence of a flow of an electric charge from a power source such as a battery or rectifier connected to an anode and cathode in contact with the electroless deposition solution. Electroless deposition may be thought of as a self-sustaining charge transfer process in which reducing electrons are obtained from a solution derived compound rather than external electric current via electrodes. The process optimally takes place only at the surface of the substrate exposed to the electroless deposition solution.

Applicants have found that under conditions such as those disclosed herein, an appropriate combination of electroless deposition solvent, the substrate, and the soluble source of deposition cations in solution, enables electroless deposition a very low concentration or absence of additives to the electroless deposition solution. Additives known in the art include reducing agents and complexing agents. In one example when using brass substrate materials, an aqueous electroless deposition solution results in dissolution of zinc from the brass at the substrate surface due to galvanic effects. The zinc cations in solution at the substrate surface act as a source of electrons allowing electroless deposition of a cation such as bismuth (III) in solution without an additional reducing agent. This process is similarly applicable using a copper substrate. With respect to an ethylene glycol electroless deposition solution, an appropriate combination of the substrate and the soluble source of deposition cations in the ethylene glycol solvent allows the ethylene glycol itself to act as a reducing agent enabling electroless deposition without the aid of solution additives.

Electroless deposition is readily adaptable to large industrial scale deposition and fabrication in bulk on a variety of substrate material compositions and substrate types such as foils, plates, and micro/nanoparticles. The method may be customized to generate amorphous or crystalline and porous or solid material coatings onto substrates of copper, brass, carbon, and silicon.

Additional benefits to the production of composite materials as in the disclosed method include the ability to characterize the resulting product and the ability to further process the product. The deposited coating may be characterized using X-ray Diffraction (XRD), Transmission Electron Microscopy (TEM), Scanning Electron Microscope (SEM), Inductively Coupled Plasma (ICP) and other means known in the art. Coated substrates such as particles may be further processed using means such as high energy ball milling processing to aid in forming homogenous coating-substrate alloys with grain sizes within a desired advantageous range. Grain size is a significant property known in the field as denoting the average individual crystallite size in a polycrystalline metal exclusive of twinned regions and subgrains when present.

Ball milling is a solid-state powder processing technique involving repeated cold welding, fracturing, and re-welding of particles in a high-energy ball mill. The mechanical alloying accomplished through ball milling is capable of synthesizing a variety of equilibrium and non-equilibrium alloy phases starting from Mended elemental or pre-alloyed powders, and finds particular application blending particles of multiple materials into an alloy. The basic mechanism of mechanical alloying is repeated deformation, fracture and cold welding by high energetic ball collisions. Dominant processes during milling include as fracturing, welding and micro-forging. A particle may become smaller through fracturing or may grow through agglomeration. It is a means for further processing composite particles with controlled, extremely fine microstructures, and can be used to produce alloys that are difficult or impossible to produce by conventional melting and casting techniques.

Previous methods using electroless deposition to develop suitable composite materials for use as battery anodes have met with difficulty and are prohibitive to perform on an industrial scale. Development of an Electroless Method to Deposit Corrosion-Resistant Silicate Layers on Metallic Substrates is exemplary of conventional method of electroless deposition. 153 J. Electrochem. Soc. B253-259 (2006). The method discloses the deposition of a silicate layer on a galvanized steel panel. The method relies on an aqueous solution of sodium silicate in the presence of sodium borohydride as a reducing agent. A galvanized steel panel was exposed to the solution and a layer of silica was deposited onto the surface. The silica layer was found to deposit in “well-defined hexagonal structures which are characteristic of zinc deposit” indicating silica coating reproduced the structure of the underlying zinc substrate. As the deposition layer mimicked the crystalline structure of the substrate, it would be vulnerable to similar expansion as the substrate if used in a conducting setting. Further, the layer deposited was not pure silicon and the method relied on additional reducing agents being used in the aqueous solution.

U.S. Pat. No. 5,306,335 relates to the electroless plating of bismuth onto metal substrates. The method discloses deposition again in an aqueous solution with the use of a trivalent salt of bismuth, a bivalent water soluble compound of tin as a reducing agent, and a complexing agent. The disclosure highlights the difficulties in electroless plating using reducing and complexing agents. For example with complexing agents, no detailed study was performed using EDTA since the plating bath would decompose when the concentration was low and plating would not occur when the concentration was higher. Consequently, acceptable results were unobtainable. The deposition results were the inverse using a citrate complexing agent. While there was a small concentration window when plating would occur, a low concentration prohibited plating while a high concentration caused the bath to decompose. The method exemplifies the significant complexity and unpredictable effects involved in selecting and maintaining reagents and their respective concentrations.

Provided herein is a method for the production of composite materials through electroless deposition comprised of coating bismuth, antimony, silicon, tin, and cobalt onto substrates comprised of copper, brass, silicon, and carbon. The method provides a coating on a substrate in an environmentally friendly scalable process at room temperatures. The methodology has particular applicability to the production of materials for battery anodes as the resulting materials significantly avoid failure due to lattice expansion upon lithium intercalation and offer high energy density with long term stability and coulombic efficiency.

These and other objects, aspects, and advantages of the present disclosure will become better understood with reference to the accompanying description and claims.

### SUMMARY

The method disclosed herein is directed to the preparation of composite materials through formation of coatings of bismuth, antimony, silicon, tin, and cobalt, as well as their various compositional alloys onto copper, brass, carbon, and silicon substrates using electroless deposition. The method disclosed is particularly useful for forming materials with characteristics advantageous for their use in battery electrodes. The method discloses electroless deposition solutions containing soluble ions of the respective coating materials. The electroless deposition solutions may utilize water or ethylene glycol as the solvent. The deposition substrate may be a bulk material such as a foil, micro or nanosize particles, or a material such as carbon foam. The method is advantageous over competing methods in that it creates less waste, can take place at relatively low temperatures in a short reaction time, and is easily scalable.

The method disclosed herein utilizes preparation of a solution comprising a solvent and one or more soluble sources of deposition cations of the material to be deposited, then immersing a suitable substrate into the electroless deposition solution. The solution conditions including temperature, agitation, and time of deposition may be varied to achieve the desired coating characteristics such as grain size, porosity, thickness and deposition rate.

The method disclosed utilizes a liquid solvent during electroless deposition. Defined herein, a solvent is a liquid in which the soluble sources of ions of the material or materials intended for deposition dissolve, forming a solution where the cations are generally uniformly distributed throughout the solution. In one embodiment, the solvent in the electroless deposition solution is water, forming an aqueous solution. In another embodiment, the solvent in the electroless deposition solution is ethylene glycol, forming a nonaqueous solution. In a nonlimiting exemplary electroless deposition solution to deposit bismuth onto a suitable substrate, an aqueous electroless deposition solution is formed through the addition of 3.15 g of the chloride salt of bismuth (III), BiCl₃, to 100 mL of ethylene glycol as the solvent to form a 0.1 M solution.

The substrate structure may be any feasible to electroless deposition. Exemplary structures are foils, wires, plates, pellets, and particles. Brass, as defined herein, is an alloy primarily consisting of copper and zinc with the possible inclusion of other minor constituent materials and where the proportion of copper is at least 50%. With respect to carbon, various exemplary forms are graphite, graphene, foam, and fibers.

Exemplary particles suitable for the method include micro/nanoparticles of copper, brass, silicon, and carbon of a representative diameter in the range of about 100 nm to 1000 nm. Within this disclosure, the term “representative diameter” means a diameter based on replacing a given particle with an imaginary sphere having a property identical with the particle, and includes volume based particle size, weight based particle size, area based particle size, and hydrodynamic/aerodynamic particle size definitions. The representative diameter will typically refer to an average particle size in the particle size distribution of a polydisperse plurality of particles, and may include discrete size ranges within the plurality. The representative diameter may be determined through laser diffraction methods, sieve analysis, optical granulometry, electron micrograph, or other means known in the art. Typically, the requirements of this disclosure with respect to representative diameter specifications will be met through a sizing specification provided by a manufacturer of powder particles, where the manufacturer provides size data based on one of the methods delineated above and executed in accordance with ISO or other standardizing bodies.

The substrate may be pretreated prior to undergoing the method disclosed herein. Treatments include methods such as washing the substrate with an acidic solution to clean ionic contaminates from the surface. With respect to pretreatment of carbon substrates, it is advantageous to catalyze the surface through application of at least a partial film of copper, silver, palladium, and combinations thereof.

The electroless deposition solutions as utilized herein have low concentration or absence of additive components including additional reducing agents and complexing agents. As disclosed supra, the combination of solvent, substrate, and the soluble source of ions allows deposition to occur with a low concentration or absence of an additional reducing agent. A reducing agent is a substance that affects reduction by donating electrons to another substance such as the metallic ion in solution. An additional reducing agent is one where a reagent acting as a source of reducing electrons is added to the electroless deposition solution in addition to the solvent, the soluble source of ions for deposition, and the substrate. When using a substrate such as brass, zinc dissolves from the brass at the substrate surface due to galvanic effects. The zinc ions entering solution at the substrate surface act as a source of reducing metal ions present in solution allowing electroless deposition of a cation in solution such as bismuth without need of a significant concentration of an additional reducing agent. With respect to the solvent ethylene glycol, the solvent itself is able to act as the reducing agent, negating the need of an additional reducing agent in solution.

Reducing agents known in the art include exemplary compounds such as formaldehyde, potassium borohydride, and dimethylamine borane. In one embodiment, the reducing agent is concentration is below 0.02M. In a preferred embodiment, the reducing agent concentration is below 0.01M. In a more preferred embodiment, there is no additional reducing agent added to the solution.

Complexing agents are known in the art and are used as a complexant to keep the cation dissolved in the solution, to minimize reaction homogenous interaction between the deposition cations in the bulk solution, and to improve adhesion of the deposited cation onto the substrate. Complexing agents join with metallic ions present in the solution to create a complex by forming typically weak ligand type bonds between the complexing agent and metallic ion. Exemplary complexing agents known in the art include hypophosphite, citrate, EDTA, and thiourea. Preferentially, the complexing agent present in the deposition solution is EDTA. More preferentially, complexing agent present in the deposition solution is thiourea. In one embodiment, the complexing agent concentration is below 0.85. In another embodiment, there is no complexing agent added to the solution.

The method disclosed provides for the deposition of one or more deposition materials during a single time period of immersion of the substrate. When the desired deposition coating is an alloy of two or more deposition materials, the respective individual materials to be alloyed in the coating are in solution and deposit during a single immersion. Additionally, the substrate material may be immersed in a first electroless deposition solution of a first solvent and a first soluble source or sources of deposition cations, then the substrate may be removed and be successively immersed in a second electroless deposition solution of a second solvent and a second soluble source or sources of deposition cations in order to create a successive layer or layers of deposition materials onto the substrate. The second electroless deposition solution may utilize the same or a different solvent from the first electroless deposition solution. Additionally, the second source or sources of deposition cations will have at least one different cation different from the first source or sources of deposition cations.

After the period of immersion the coated substrates may be cleaned of excess electrolyte, or may be further processed. A potential method for further processing a foil type substrate includes die punching out coated chads for use as battery anodes. A potential method for processing nanoparticle substrates includes ball milling the coated nanoparticles then combining them with a binder to create a paste for extrusion into battery anodes.

### BRIEF DESCRIPTION OF THE DRAWINGS

FIG. 1. illustrates the deposition scheme of adding a catalytic surface to a carbon material, then coating the carbon material through the electroless deposition method as claimed.

### DETAILED DESCRIPTION OF THE EMBODIMENTS

The following description is provided to enable any person skilled in the art to use the invention and sets forth the best mode contemplated by the inventor for carrying out the invention. Various modifications; however, will remain readily apparent to those skilled in the art, since the principles of the present invention are defined herein specifically to provide a method for electroless deposition of bismuth, antimony, silicon, tin, and cobalt individually as well as their various compositional alloys directly onto various substrate materials copper, brass, carbon, and silicon.

The method disclosed herein utilizes an electroless deposition method where the substrate material is immersed by placement in a solution comprising a solvent and a soluble source of cations to be deposited. In one embodiment the solvent is water. In another embodiment the solvent is ethylene glycol. The substrate materials may be comprised of copper, brass, carbon, and silicon. The structure of the substrate material may be any known in the art as suitable on which to base the deposition. Exemplary structures are foil, sheets, pellets, and nanoparticles of a size in the range of about 100 nm and 1000 nm. The soluble source of ions are the soluble salts of the desired deposition materials bismuth, antimony, silicon, tin, and cobalt.

According to the present invention, low concentrations or an absence of additional reagents such as reducing agents or complexing agents are allowed to carry out the method. The temperature of the electroless deposition bath is between about 25° C. and about 95° C. and may be adjusted to optimize the desired deposition characteristics such as deposition rate, thickness, porosity, and grain size. Generally, as the temperature of the plating bath is increased, the rate of deposition will increase. The temperature may also affect qualities of the plating such as density and porosity. Additionally, the method may be performed with immersion of the substrate into the deposition bath in either stagnant conditions or with energy added to the solution by agitation, stirring, sonication, or other methods known in the art in order to optimize desired deposition characteristics. Although not limiting, experimentation has found stagnant conditions optimal for deposition onto foil or other large surfaces, while immersion in agitated conditions is preferable for deposition onto nano-scale particles.

The soluble source or sources of ions are the soluble salts of the deposition cations bismuth, antimony, silicon, tin, and cobalt. In a preferred embodiment, the soluble sources of the deposition cations are the halide salts of bismuth, antimony, silicon, tin, and cobalt. In a more preferred embodiment, the soluble sources of the deposition cations are the chloride salts of bismuth, antimony, silicon, tin, and cobalt. Exemplary sources of ions for the deposition of antimony and bismuth include antimony (III) chloride (SbCl₃) and bismuth (III) chloride (BiCl₃). Similarly, tin (II) chloride (SnCl₂), silicon (IV) tetrachloride (SiCl₄), and cobalt (II) chloride (CoCl₂) are exemplary sources of soluble ions for the deposition of tin, silicon, and cobalt. The concentration of the soluble source of ions in the electroless deposition solutions is in an amount in excess of 0.01M and less than 0.4M. When more than one source of ions is in solution, the concentration reflects the concentration of each source of ions respectively.

The method disclosed provides for the deposition of one or more deposition materials during a single period of immersion of the substrate. When the desired deposition coating is a single material, a soluble source of cations of that material is in solution and deposits onto the surface of the substrate during the period of immersion. When the desired deposition coating is an alloy of two or more deposition materials, the respective individual materials to be alloyed in the coating are in solution and deposit during a single immersion. Consequently, the solution may comprise a single source of deposition cations (ex: BiCl₃), multiple sources of a single deposition cation (ex: BiCl₃ and BiBr₃), sources of multiple different cations for deposition (ex: BiCl₃ and SbCl₃), and combinations thereof. Additionally, the substrate material may be immersed in a first deposition solution of a first solvent, a first soluble source or sources of deposition cations, then the substrate may be removed and be successively immersed in a second electroless deposition solution a second solvent, a second source or sources of deposition cations where at least one of the sources is different from the first soluble source or sources of deposition cations, to create a successive layer or layers of deposition material onto the substrate. In a nonlimiting example, a brass substrate may be immersed in a first electroless deposition solution of an aqueous solution of SnCl₂, removed from the first electroless deposition after a first time period of immersion, then successively immersed a second electroless deposition solution of an ethylene glycol solution of BiCl₃ and SbCl₃.

Substrate materials may be formed of copper, brass, carbon, and silicon. The substrate materials may be treated prior to immersion in the electroless deposition solution in order to speed deposition, ensure uniformity of the deposited coating, or tailor the quality of the deposited coating. The treatment may involve cleaning the surface of the substrate to free any ionic deposits or scaling to ensure the surface is available for interaction with the soluble source or sources of deposition cations in the electroless deposition solution. A common and acceptable method of cleaning copper or brass foil prior to immersion is to wash the foil in a bath of dilute nitric acid and water. The foils are then immediately immersed in the deposition solution. Copper and brass nanoparticles are preferentially immersed into the electroless deposition solution without preparation.

Carbon substrates include materials such as carbon fibers, carbon foams, graphene, and carbon particles of a size from about 100 nm to 1000 nm. The carbon substrates may be prepared through catalyzation of the surface prior to immersion in the electroless deposition solution. Catalyzation is accomplished through at least partially coating the surface of the substrate with a coating of copper, silver, palladium, and combinations thereof. Methods of accomplishing catalyzation of the substrate are known in the art. Exemplary methods include electrodeposition of silver onto carbon nanotubes. S. Hussain & A. Pal Incorporation of Nanocrystalline Silver on Carbon Nanotubes by Electrodeposition technique 62 Material Letters. 1874, (2008). An additional exemplary method is electrodeposition of palladium nanoparticles on carbon nanotubes. Yungang Sun et al. Electrodeposition of Pd Nanoparticles on Single-walled Carbon Nanotubes for Flexible Hydrogen Sensors, 90 Applied Physics Letters, 213107, (2007).

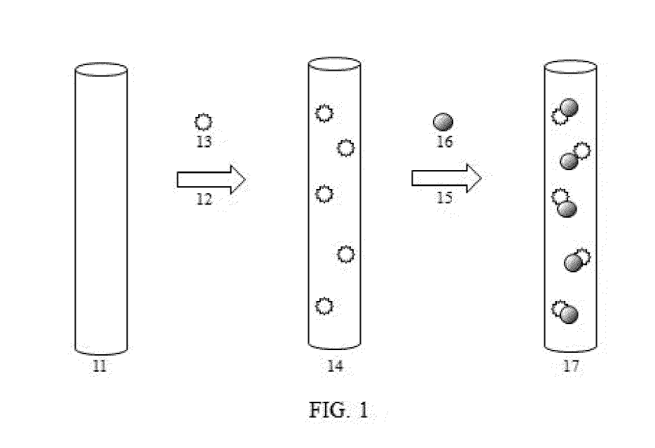

FIG. 1 is illustrative of the method for producing a composite material by catalyzation of a carbon fiber substrate followed with electroless deposition. A carbon fiber 11 is catalyzed in a step 12 through the application of an at least partial coating of a catalyst 13 comprising copper, silver, palladium, or combinations thereof onto the surface of the carbon fiber 11, to form a catalyzed carbon fiber 14. The catalyst 13 may be added through a process such as electrodeposition as referenced above. The catalyzed carbon fiber 14 then undergoes a step 15 electroless deposition as disclosed herein. During a period of immersion, a deposition material 16 deposits onto the surface of the catalyzed carbon fiber 14 and forms a composite material 17. The composite material 17 may then be utilized or further processed for use in applications such as battery anodes.

The electroless deposition solutions including the aqueous and ethylene glycol based solutions may have conditions preferential to achieve desired deposition characteristics such as deposition rate, coating porosity, and grain size. The electroless deposition may occur at room temperature. To increase the rate of deposition, the temperature of the solution is increased. An increase in temperature allows deposition of a thicker coating in a shorter deposition period. Further, the electroless deposition solution may be stagnant or agitated to vary the rate and quality of the deposition coating. Agitation of the solution is accomplished through such exemplary means as stirring, sonication, and shaking. The time period of immersion may be varied to achieve the desired coating thickness and porosity. The pH of the solution may be altered in order to alter solution characteristic. For example, an acidic solution may be utilized to increase the rate of solubility of the source or sources for deposition ions. Means known in the art to alter the pH include the addition of acids, bases, or buffers. Exemplary compounds include HCl, H₂SO₄, and succinic acid. In a nonlimiting example, an aqueous electroless deposition solution may have a 1M concentration of HCl in order to aid dissolution of the soluble source of ions. In an additional nonlimiting example, there is no reagent addition to adjust the pH of an ethylene glycol electroless deposition solution.

After the substrate has been coated by the source of soluble ions during the period of immersion, the substrate is removed. The coated substrate may then be washed in solvent or solution to clean remaining electrolyte from the coated substrate. An appropriate cleaning solvent such as acetone is capable of carrying away the deposition solution without dissolution of the applied coating on the substrate.

The layer deposited onto the surface of the substrate as generated by the methodology is described as typically crystalline in nature. The deposited layer is crystalline when the atoms deposited are in a highly ordered lattice, versus amorphous where it lacks a crystal lattice or any order to the atoms and there arrangement is in no specific pattern. The layer deposited onto the surface of the substrate generated by the methodology may also be porous. The layer deposited is porous when the coating films having macro to nano-scale cavities structurally. Both crystalline and amorphous films generated can be porous. Practitioners of ordinary skill in the art will recognize the thickness of the layer deposited is dependent upon the length of time period of immersion, solution temperature, concentration, whether a catalytic layer is present, and so on. A representative thickness of the deposition layer is 2-5 microns when depositing antimony onto brass foil using a solution of 0.10M SbCl₃ in ethylene glycol, at 80° C., with an immersion time of 20 minutes.

The coated substrates are available immediately for use or may be further processed. In one example, the product resulting from the method disclosed is a bismuth and antimony alloy coated brass foil. To further process the product for use as a battery anode, the coated foil is subjected to a die punch. The die punches out a coated chad that may be used as the anode. Likewise, the resulting perforated sheet may be used. In another example, silicon coated copper nanoparticles are subjected to ball milling. The ball milling further processes the coated particle to form a homogenous alloy of grain sizes within a desired range or to form an amorphous alloy. The coated particles generated from the disclosed method may also be mixed with other materials such as graphite nanoparticles and a binding agent to form a paste, then tape casting the paste onto conductive sheets to be used as battery anodes.

### Example 1

Electroless deposition of bismuth on brass foil in ethylene glycol: An electroless deposition solution of bismuth was prepared as follows. A solution of 0.1M bismuth chloride in ethylene glycol was prepared by addition of the bismuth chloride to the solvent. The solution was formed at 80° C. with stirring until the solution was clear.

Next, brass foil was prepared by etching in dilute nitric acid followed by washing in deionized water. Plating tape was then placed over portions of the foil in order to prevent deposition on those areas as a control.

The brass foil was then immersed for two minutes in the stagnant electroless deposition solution maintained at 80° C. The foil was then removed from the solution and washed of the solution in acetone. The foil was allowed to air dry.

The present inventors found the color appearance of the foil had changed from brass to lustrous silver. The inventors confirmed the resulting deposition using various techniques including scanning electron microscopy (SEM).

### Example 2

Electroless deposition of antimony on copper nanoparticles in ethylene glycol. An electroless deposition solution of antimony was prepared as follows. A solution of 0.1M antimony chloride in ethylene glycol was prepared by addition of the antimony chloride to the solvent. The solution was formed at 80° C. with stirring until the solution was clear.

While stirring the clear solution, 1 gram micron size particles of copper was added to the solution. The particle/deposition solution was agitated for five minutes with intermediate ultra-sonication and vigorous agitation. After the period of immersion, the particles were filtered from the solution, washed with acetone, and allowed to air dry.

The present inventors found the color appearance of the particles had changed from red to a rust color, indicative of the deposition of antimony onto the copper nanoparticles.

### Example 3

Electroless deposition of bismuth and antimony on copper foil: An electroless deposition solution of antimony and bismuth was prepared as follows. A solution of 0.1M antimony chloride and 0.1M bismuth chloride in ethylene glycol was prepared by addition of the antimony chloride and bismuth chloride to the solvent. The solution was formed at 80° C. with stirring until the solution was clear.

Next, copper foil was prepared by etching in dilute nitric acid followed by washing in deionized water. Plating tape was then placed over portions of the foil in order to prevent deposition on those areas as a control.

The copper foil was then immersed for 20 minutes in the stagnant electroless deposition solution maintained at 80° C. The foil was then removed from the solution, washed in acetone, and allowed to air dry.

### Example 4

Electroless deposition of Si on brass foil: An electroless deposition solution of silicon was prepared as follows. A solution of 0.1M silicon tetrachloride in ethylene glycol was prepared by addition of the anhydrous tin chloride to the solvent. The solution was formed at 80° C. with stirring until the solution was clear.

Next, brass foil was prepared by etching in dilute nitric acid followed by washing in deionized water. Plating tape was then placed over portions of the foil in order to prevent deposition on those areas as a control.

The brass foil was then immersed for two minutes in the stagnant electroless deposition solution maintained at 80° C. in a sealed vessel. The foil was then removed from the solution and washed of the solution in acetone. The foil was allowed to air dry.

The present inventors found the color appearance of the foil had changed from brass to yellow-orange in color. The inventors analyzed the resulting deposition using various techniques including scanning electron microscopy (SEM).

### Example 5

Electroless deposition of antimony on carbon nanoparticles in ethylene glycol. An electroless deposition solution of antimony was prepared as follows. A solution of 0.1M antimony chloride in ethylene glycol was prepared by addition of the antimony chloride to the solvent. The solution was formed at 80° C. with stirring until the solution was clear.

The carbon micron size particles were catalyzed by addition of at least a portion of the surface with palladium. Catalyzation of the surface was accomplished by electrodeposition of silver onto 100 nm sized carbon particles.

While stirring the clear solution, 1 gram of catalyzed carbon micron size particles was added to the solution. The particle/deposition solution was agitated for five minutes with intermediate ultra-sonication and vigorous agitation. After the period of immersion, the particles were filtered from the solution, washed with acetone, and allowed to air dry.

### Example 6

Electroless deposition of bismuth, antimony, and tin on brass foil in water: An electroless deposition solution of bismuth, antimony, and tin was prepared as follows. A solution was prepared by the addition of 0.38M H₂SO₄ and 0.65M HCl to water. The pH was acidic (approximately pH=1). A solution of 0.02M bismuth chloride. 0.02M antimony chloride, and 0.02M tin chloride and 0.65M thiourea were dissolved in the solution. The solution was formed at 80° C. with stirring until the solution became clear.

Next, brass foil was prepared by etching in dilute nitric acid followed by washing in deionized water. Plating tape was then placed over portions of the foil in order to prevent deposition on those areas as a control.

The brass foil was then immersed for three minutes in the stagnant electroless deposition solution maintained at 80 C. The foil was then removed from the solution and washed of the solution in acetone. The foil was allowed to air dry.

The present inventors found the color appearance of the foil had changed from brass to lustrous silver. The inventors confirmed the resulting deposition using various techniques including scanning electron microscopy (SEM), x ray diffraction (XRD) and Inductively Coupled Plasma (ICP).

### Example 7

Electroless deposition of bismuth, antimony, and tin on copper foil in water: An electroless deposition solution of bismuth, antimony, and tin was prepared as follows. A solution was prepared by the addition of 0.38M H₂SO₄ and 0.65M HCl to water. The pH was acidic (approx.=1). Thiourea was added to the solution to achieve a concentration of 0.65M. A solution of 0.02M bismuth chloride. 0.02M antimony chloride, and 0.02M tin chloride and 0.65M thiourea were dissolved in the solution. The solution was formed at 80° C. with stirring until the solution became clear.

Next, copper foil was prepared by etching in dilute nitric acid followed by washing in deionized water. Plating tape was then placed over portions of the foil in order to prevent deposition on those areas as a control.

The copper foil was then immersed for three minutes in the stagnant electroless deposition solution maintained at 60° C. The foil was then removed from the solution and washed of the solution in acetone. The foil was allowed to air dry.

The present inventors found the color appearance of the foil had changed from copper to lustrous silver. The inventors confirmed the resulting deposition using various techniques including scanning electron microscopy (SEM), x ray diffraction (XRD) and Inductively Coupled Plasma (ICP).

It is to be understood that the above-described arrangements are only illustrative of the application of the principles of the present invention and it is not intended to be exhaustive or limit the invention to the precise form disclosed. Numerous modifications and alternative arrangements may be devised by those skilled in the art in light of the above teachings without departing from the spirit and scope of the present invention. It is intended that the scope of the invention be defined by the claims appended hereto.

In addition, the previously described versions of the present invention have many advantages, including but not limited to those described above. However, the invention does not require that all advantages and aspects be incorporated into every embodiment of the present invention.

All publications and patent documents cited in this application are incorporated by reference in their entirety for all purposes to the same extent as if each individual publication or patent document were so individually denoted.

We claim:

1. A method of preparing composite materials comprising:
preparing a first electroless deposition solution where the first electroless deposition solution comprises a first solvent, one or more first soluble sources of deposition cations, a reducing agent, and a complexing agent where,
the one or more first soluble sources of deposition cations is selected from the group of soluble salts of bismuth, antimony, silicon, tin, and cobalt,
the one or more first soluble sources of deposition cations are present in an amount in excess of 0.01M and less than 0.4M,
the reducing agent is present in an amount below 0.02M,
the complexing agent is present in an amount below 0.85M,
the first electroless deposition solution has a temperature from about 25° C. and about 95° C.; and
immersing for a first time period of immersion in the range of about 30 seconds to about 60 minutes in the first electroless deposition solution, a substrate where the substrate comprises copper, brass, silicon, carbon, or combinations thereof.

2. The method of claim 1 further comprising:
removing the substrate from the first electroless deposition solution at the end of the first time period of immersion; and
immersing the substrate for a second time period of immersion in the range of about 30 seconds to about 60 minutes in a second electroless deposition solution where the second electroless deposition solution comprises a second solvent, one or more second soluble sources of deposition cations, a reducing agent, and a complexing agent where,
the one or more second soluble sources of deposition cations is selected from the group of soluble salts of bismuth, antimony, silicon, tin, and cobalt,
one or more of the one or more second soluble sources of deposition cations is different than the first soluble sources of deposition cations,
the one or more second soluble sources of ions are present in an amount in excess of 0.01M and less than 0.4M,
the reducing agent is present in an amount below 0.02M,
the complexing agent is present in an amount below 0.85M, and
the second electroless deposition solution has a temperature from about 25° C. and about 95° C.

3. The method of claim 2 where the first solvent is ethylene glycol.

4. The method of claim 2 where the first solvent is water.

5. The method of claim 1 where the substrate is a plurality of particles having a diameter of about 100 nm to about 1000 nm.

6. The method of claim 5 where the first solvent is ethylene glycol.

7. The method of claim 6 further comprising:
removing the substrate from the first electroless deposition solution after the first time period of immersion; and
subjecting the substrate to a high energy ball milling process.

8. The method of claim 6 further comprising:
removing the substrate from the first electroless deposition solution at the end of the first time period of immersion; and
immersing the substrate for a second time period of immersion in the range of about 30 seconds to about 60 minutes in a second electroless deposition solution where the second electroless deposition solution comprises a second solvent, one or more second soluble sources of deposition cations, a reducing agent, and a complexing agent where,
the one or more second soluble sources of deposition cations is selected from the group of soluble salts of bismuth, antimony, silicon, tin, and cobalt,
one or more of the one or more second soluble sources of deposition cations is different than the first soluble sources of deposition cations,
the one or more second soluble sources of ions are present in an amount in excess of 0.01M and less than 0.4M,
the reducing agent is present in an amount below 0.02M,
the complexing agent is present in an amount below 0.85M, and
the second electroless deposition solution has a temperature from about 25° C. and about 95° C.

9. The method of claim 8 further comprising:
removing the substrate from the second electroless deposition solution after the second time period of immersion; and
subjecting the substrate to a high energy ball milling process.

10. The method of claim 5 where the first solvent is water.

11. The method of claim 10 further comprising:
removing the substrate from the first electroless deposition solution after the first time period of immersion; and
subjecting the substrate to a high energy ball milling process.

12. The method of claim 10 further comprising:
removing the substrate from the first electroless deposition solution at the end of the first time period of immersion; and
immersing the substrate for a second time period of immersion in the range of about 30 seconds to about 60 minutes in a second electroless deposition solution where the second electroless deposition solution comprises a second solvent, one or more second soluble sources of deposition cations, a reducing agent, and a complexing agent where,
the one or more second soluble sources of deposition cations is selected from the group of soluble salts of bismuth, antimony, silicon, tin, and cobalt,
one or more of the one or more second soluble sources of deposition cations is different than the first soluble sources of deposition cations,
the one or more second soluble sources of ions are present in an amount in excess of 0.01M and less than 0.4M,
the reducing agent is present in an amount below 0.02M,
the complexing agent is present in an amount below 0.85M, and
the second electroless deposition solution has a temperature from about 25° C. and about 95° C.

13. The method of claim 12 further comprising:
removing the substrate from the second electroless deposition solution after the second time period of immersion; and
subjecting the substrate to a high energy ball milling process.

14. The method of claim 1 where the substrate is carbon having a catalyzed surface where the catalyzed surface comprises an at least partial film of copper, silver, palladium, or combinations thereof.

15. The method of claim 14 where the substrate is a plurality of particles having a diameter of about 100 nm to about 1000 nm.

16. The method of claim 15 further comprising:
removing the substrate from the first electroless deposition solution after the time period of immersion; and
subjecting the substrate to a high energy ball milling process.

17. The method of claim 14 further comprising:
removing the substrate from the first electroless deposition solution at the end of the first time period of immersion; and
immersing the substrate for a second time period of immersion in the range of about 30 seconds to about 60 minutes in a second electroless deposition solution where the second electroless deposition solution comprises a second solvent, one or more second soluble sources of deposition cations, a reducing agent, and a complexing agent where,
the one or more second soluble sources of deposition cations is selected from the group of soluble salts of bismuth, antimony, silicon, tin, and cobalt,
one or more of the one or more second soluble sources of deposition cations is different than the first soluble sources of deposition cations,
the one or more second soluble sources of ions are present in an amount in excess of 0.01M and less than 0.4M,
the reducing agent is present in an amount below 0.02M,
the complexing agent is present in an amount below 0.85M, and
the second electroless deposition solution has a temperature from about 25° C. and about 95° C.

18. A method of preparing composite materials comprising:
preparing a first electroless deposition solution where the first electroless deposition solution comprises a first solvent, two or more first soluble sources of deposition cations, a reducing agent, and a complexing agent where,
the one or more first soluble sources of deposition cations is selected from the group of soluble salts of bismuth, antimony, silicon, tin, and cobalt,
the one or more first soluble sources of deposition cations are present in an amount in excess of 0.01M and less than 0.4M,
the reducing agent is present in an amount below 0.02M,
the complexing agent is present in an amount below 0.85M,
the first electroless deposition solution has a temperature from about 25° C. and about 95° C.; and
immersing for a first time period of immersion in the range of about 30 seconds to about 60 minutes in the first electroless deposition solution, a substrate where the substrate comprises copper, brass, silicon, carbon, or combinations thereof.

19. The method of claim 18 where the two or more first soluble sources of deposition cations are soluble salts of bismuth and antimony and the substrate comprises copper, brass, or a combination thereof.

20. The method of claim 19 where the solvent is ethylene glycol.

21. The method of claim 20 where the substrate is a plurality of particles having a diameter of about 100 nm to about 1000 nm.

22. The method of claim 21 further comprising:
removing the substrate from the first electroless deposition solution after the time period of immersion; and
subjecting the substrate to a high energy ball milling process.

23. The method of claim 19 where the solvent is water.

24. The method of claim 23 where the substrate is a plurality of particles having a diameter of about 100 nm to about 1000 nm.

25. The method of claim 24 further comprising:
removing the substrate from the first electroless deposition solution after the time period of immersion; and
subjecting the substrate to a high energy ball milling process.
